(19) United States
(12) Patent Application Publication
(10) Pub. No.: US 2018/0167699 A1
(43) Pub. Date: Jun. 14, 2018

(54) COLLABORATIVE MEDIA DISTRIBUTION SYSTEM AND METHOD OF USING SAME

(71) Applicant: LOKI, LLC, Woodbridge, CT (US)

(72) Inventors: Andrew Ginzberg, Woodbridge, CT (US); Jeffrey Santi, Willimantic, CT (US); Brian Kelleher, Newington, CT (US); Case Polen, Old Saybrook, CT (US)

(73) Assignee: LOKI, LLC, Woodbridge, CT (US)

(21) Appl. No.: 15/838,923

(22) Filed: Dec. 12, 2017

Related U.S. Application Data
(60) Provisional application No. 62/433,522, filed on Dec. 13, 2016.

(51) Int. Cl. H04N 21/858; H04L 29/08; H04N 21/235

(52) U.S. Cl. CPC H04N 21/858; H04N 21/235; H04L 67/18

(57) ABSTRACT

A system for generating aggregated data associated with an event, the system including at least one relay server; at least one communications server; and a processor, the processor configured to generate a first event area associated with a first device based on at least one of the first location and a predetermined event location; generate a second event area associated with a second device based on the second location; determine the first event area and second event area overlap, merge the first event area and the second event area into a combined event area and link the second video data with the first video data; and generate the aggregated data, in response to the linking of the first video data and the second video data, wherein the aggregated data includes the first video data and the second video data. A corresponding method and computer readable medium are also disclosed.

### CROSS REFERENCE TO RELATED APPLICATIONS

This application claims priority to and the benefit of U.S. Provisional Patent Application No. 62/433,522, filed on Dec. 13, 2016, the disclosure of which is incorporated herein by reference in its entirety.

### BACKGROUND

Traditionally, video has been considered a linear medium with time being the only variable controlling the content. The introduction of video streaming over the internet has added an additional variable of alternative quality factors of the same footage, for example, video of different resolutions.

### SUMMARY

According to aspects of the present disclosure, a system for generating aggregated data associated with an event is provided. The system includes at least one relay server, at least one communications server, and a processor in communication with at least one of the at least one relay server and the at least one communication server via a network. The processor is configured to receive first video data and first location data associated with a first device from the one or more relay server, determine a first location of the first device based on the first location data, and generate a first event area associated with the first device based on at least one of the first location and a predetermined event location. The processor is also configured to receive second video data and second location data associated with a second device from the one or more relay server, determine a second location of the second device based on the second location data, generate a second event area associated with the second device based on the second location, determine the first event area and second event area overlap, merge the first event area and the second event area into a combined event area and link the second video data with the first video data, and generate the aggregated data, in response to the linking of the first video data and the second video data. The aggregated data includes the first video data and the second video data.

According to aspects of the present disclosure, a method for generating aggregated data associated with an event is provided. The method includes, by a processor, receiving first video data and first location data from a first device, determining a first location of the first device based on the first location data, generating a first event area associated with the first device based on at least one of the first location and a predetermined event location. The method also includes receiving second video data and second location data from a second device, determining a second location of the second device based on the second location data, generating a second event area associated with the second device based on the second location, determining the first event area and second event area overlap, merging the first event area and the second event area into a combined event area and linking the second video data with the first video data, and generating the aggregated data, in response to the linking of the first video data and the second video data. The aggregated data includes the first video data and the second video data.

According to aspects of the present disclosure, a non-transitory computer-readable medium having stored thereon sequences of instructions is provided. The medium has sequences of instructions which, when executed by a processor, cause the processor to receive first video data and first location data from a first device, determine a first location of the first device based on the first location data, generate a first event area associated with the first device based on at least one of the first location and a predetermined event location, receive second video data and second location data from a second device, determine a second location of the second device based on the second location data, generate a second event area associated with the second device based on the second location, determine the first event area and second event area overlap, merge the first event area and the second event area into a combined event area and link the second video data with the first video data, and generate the aggregated data, in response to the linking of the first video data and the second video data. The aggregated data includes the first video data and the second video data.

According to aspects of the present disclosure, a method for generating aggregated data associated with an event is provided. The method includes, by a processor, receiving first video data and first location data from a first device, determining a first location of the first device based on the first location data, determining a region associated with the first device based on the first location, receiving second video data and second location data from a second device, determining a second location of the second device based on the second location data, determining the second location is within the region, associating the second video data with the first video data based on the determination that the second location is within the region, and in response to the association of the first video data and the second video data, generating the aggregated data, wherein the aggregated data includes the first video data and the second video data.

### BRIEF DESCRIPTION OF THE DRAWINGS

The foregoing aspects and other features of the disclosed embodiments are explained in the following description, taken in connection with the accompanying drawings, wherein:

FIG. 1 illustrates an overview of an exemplary embodiment of a collaborative media distribution system, according to aspects of the present disclosure;

FIG. 2 illustrates exemplary content of a graphical user interface related to a collaborative media distribution system, according to aspects of the present disclosure;

FIG. 3 illustrates exemplary content of a graphical user interface related to a collaborative media distribution system, according to aspects of the present disclosure;

FIG. 4A illustrates an exemplary event area related to an implementation of a collaborative media distribution system, according to aspects of the present disclosure;

FIG. 4B illustrates a further implementation of the exemplary event area of FIG. 4A, according to aspects of the present disclosure;

FIG. 5A illustrates an exemplary interface of event areas related to an implementation of a collaborative media distribution system, according to aspects of the present disclosure;

FIG. 5B illustrates an exemplary interface of event areas related to an implementation of a collaborative media distribution system, according to aspects of the present disclosure;

FIG. 5C illustrates an exemplary event area related to an implementation of a collaborative media distribution system, according to aspects of the present disclosure;

FIG. 5D illustrates an exemplary event area related to an alternative implementation of a collaborative media distribution system to that of the exemplary event area of FIG. 5C, according to aspects of the present disclosure;

FIG. 5E illustrates an exemplary event area related to an implementation of a collaborative media distribution system, according to aspects of the present disclosure;

FIG. 5F illustrates further implementation of the exemplary event area of FIG. 5E, according to aspects of the present disclosure;

FIG. 5G illustrates further implementation of the exemplary event area of FIG. 5F, according to aspects of the present disclosure;

FIG. 5H illustrates an exemplary event area related to an implementation of a collaborative media distribution system, according to aspects of the present disclosure;

FIG. 6A illustrates an exemplary event area related to an implementation of a collaborative media distribution system at an event location such as a stadium, according to aspects of the present disclosure;

FIG. 6B illustrates exemplary event areas related to an implementation of a collaborative media distribution system, according to aspects of the present disclosure;

FIG. 7 illustrates an exemplary flowchart related to a collaborative media distribution system, according to aspects of the present disclosure;

FIG. 8 illustrates an exemplary flowchart related to a collaborative media distribution system, according to aspects of the present disclosure;

FIG. 9 illustrates an exemplary flowchart related to a collaborative media distribution system, according to aspects of the present disclosure;

FIG. 10 illustrates an exemplary flowchart related to a collaborative media distribution system, according to aspects of the present disclosure;

FIG. 11A illustrates an exemplary event area related to an implementation of a collaborative media distribution system, according to aspects of the present disclosure;

FIG. 11B is an event timeline illustrating video streams associated with the event area of FIG. 11A, according to aspects of the present disclosure;

FIGS. 12A-12C illustrate exemplary content of a graphical user interface associated with video streams of the event area of FIG. 11A and the timeline of FIG. 11B, according to aspects of the present disclosure.

### DETAILED DESCRIPTION

The embodiments described herein disclose an adaptive streaming protocol which adds an additional layer of control to the user's experience, aggregating multiple broadcasts into a single manifest, allowing for a determination of an event's location and boundaries based on user streaming and device location as well as optimal playback of multi-perspective events. In embodiments, the user is able to select one or more live (i.e., real time) video broadcasts.

As used herein, the term “device” includes, but is not limited to any mobile device such as a smart phone, cellular phone, or wearable electronic device, any computer such as a laptop, desktop, tablet, notebook, any entertainment system such as a television, gaming system, electronic device configured to receive or transmit streaming audio or video, or any other suitable electronic device. The term “event area” means an area associated with an event based on the location(s) of one or more devices, determined by a processor, wherein the event area is a predetermined area surrounding a device or a combination of overlapping event areas surrounding a plurality of respective devices. The term “predetermined event location” means a location associated with an event known to be occurring or anticipated to occur, and having a predetermined location.

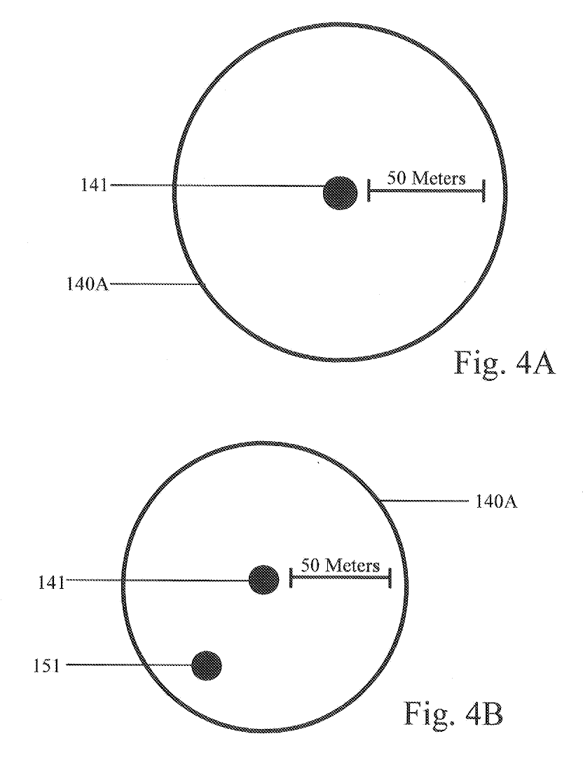

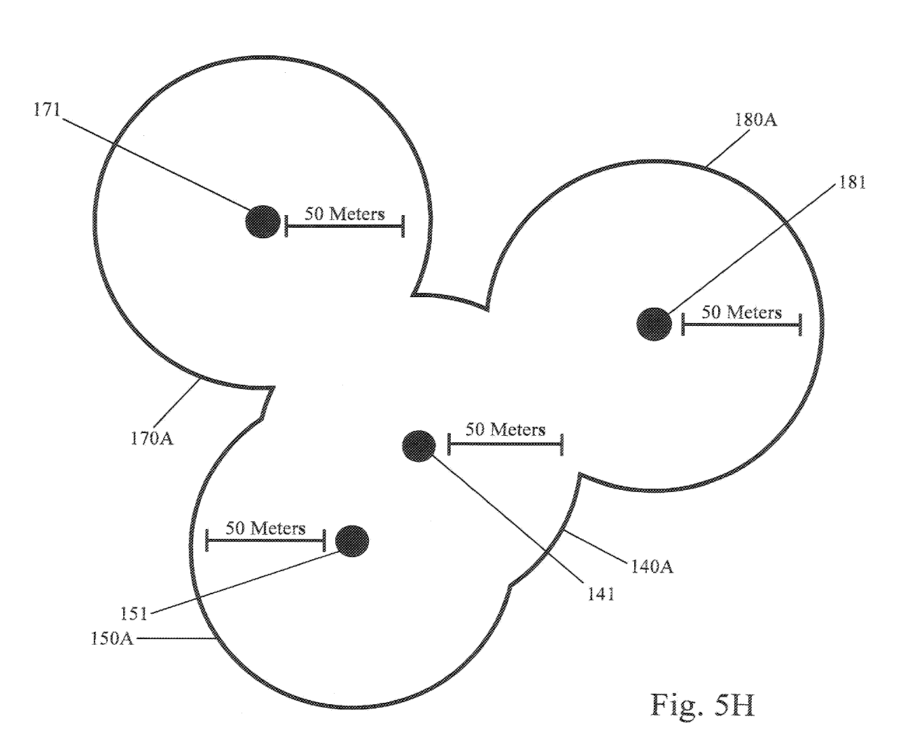

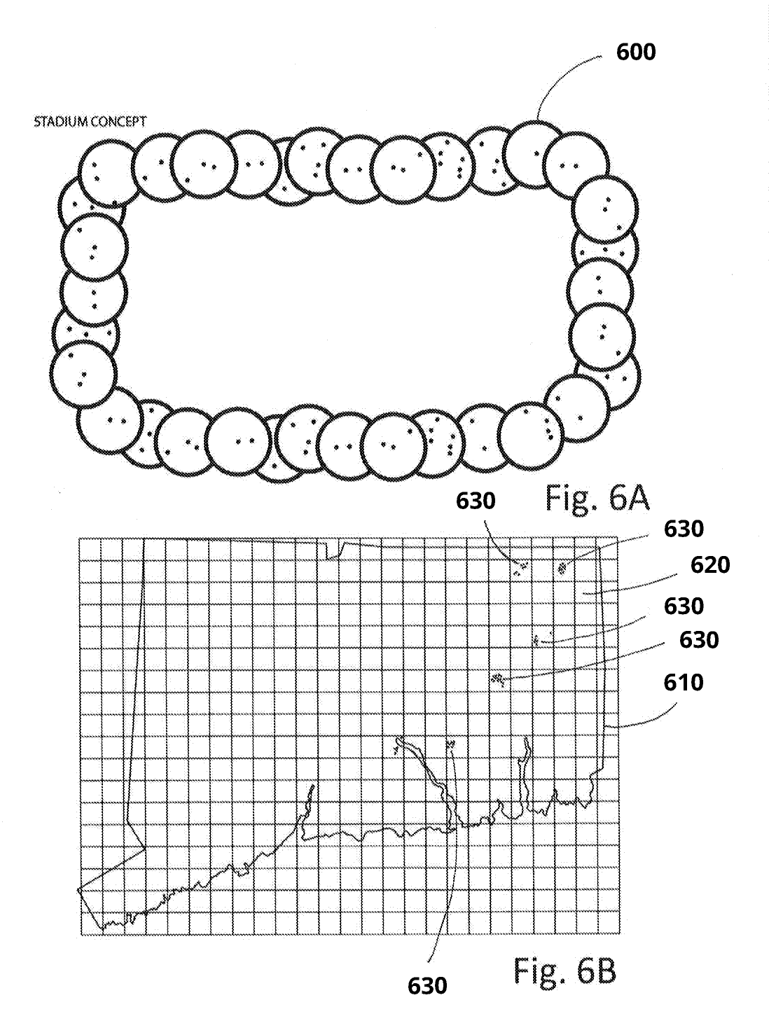

As will be described in more detail below, an exemplary system 100 may include a network of different types of servers, where each type of server may provide a service to provide user experiences to be described below. System 100 may allow a user to activate and/or accept a location/event confirmation in order to activate a live stream function on a user device. System 100 may tag or mark each live stream with location specific data, allowing proper grouping into “events.” System 100 may cluster users into events based on geo-location, such as by using a partitioning technique (as illustrated in FIGS. 4-6A). A map may be divided into regions, each of a uniform size and an internal border a fixed distance from the region boundary (as illustrated in FIG. 6B). These regions on the map may be associated with geographic boundary coordinates, and system 100 may determine whether a user can be a participant of an event in one or more particular regions. If a user is located within an internal border, then system 100 may search for one region. Event participation is determined by matching the event to the nearest user within a certain distance of that event (FIG. 4B). This parameter is specific to the event being considered and is a factor of the event size and geographic spread. If no match is found, a user is assumed to be part of a new event. As described below, communication servers of system 100 may continuously determine the event in which a potential broadcaster may be participating. Once a broadcaster begins streaming, system 100 may prompt a user for confirmation on the event, such as when the user is the first broadcaster.

System 100 may further be implemented to allow one or more users to review live and past events in full or highlight form. System 100 may allow the one or more users to review an event in its entirety by providing access to all of the live streams that were broadcast within the event. An event timeline is completed using timestamps of associated broadcasts of that event. A viewer is able to watch an event sequentially from start to finish through any of the broadcasts taken by various users. Viewers can select which broadcasts they would like to watch the event through. While watching a broadcast, the view is given access to image previews of other broadcasts happening at the same time period of the broadcast currently being watched. The viewer can then switch to different broadcasts by interacting with their associated image previews. Viewers can search through an event timeline. Broadcasts a user can access match the timeline of the overall event. System 100 may further be implemented to create highlight versions of events by editing together multiple segments of streams within any event. The streams and segments from each stream are determined by the criteria of highest number of viewers, and peak time segments of the live streams. System 100 may execute an instruction to generate a compilation of a set of streams or segments based on a rating system, and/or based on a number of views by users.

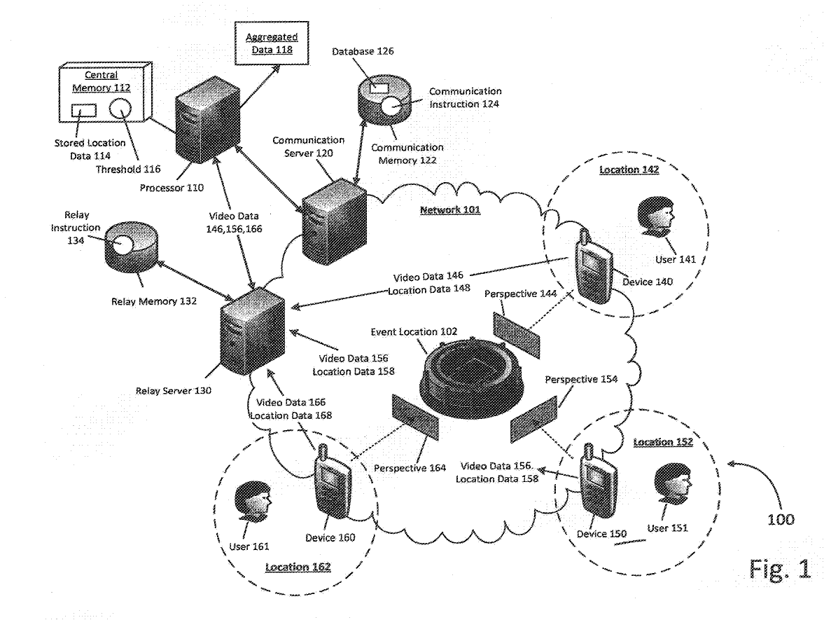

FIG. 1 illustrates an exemplary system 100 that can be used to implement collaborative media distribution, arranged in accordance with at least some embodiments described herein. System 100 may include a processor 110, at least one communication server 120, at least one relay server 130, and/or at least one device including devices 140, 150, and 160. Processor 110 may be configured to be in communication with the at least one communication server 120 and/or the at least one relay server 130. The at least one communication server 120 may be configured to be in communication with the at least one relay server 130 and/or devices 140, 150, 160. Relay server 130 may be configured to be in communication with devices 140, 150, 160. The at least one relay server 130, at least one communication server 120 and the devices 140, 150, 160 may also be arranged as a network 101. In some examples, processor 110 may be configured to control operations of the at least one communication server 120 and/or the at least one relay server 130. In some examples, processor 110 may be a processing unit of the at least one communication server 120 and/or the at least one relay server 130.

Devices 140, 150, 160 may be controlled by users 141, 151, 161, respectively. In some examples, devices 140, 150, 160 may each be a cellular phone, a smart phone, a tablet, a computer, a laptop computer, a wearable electronic device, etc., that may include image capturing devices such as a camera or a video recorder. Devices 140, 150, 160 and/or users 141, 151, 161 may be located in locations 142, 152, 162, respectively. Locations 142, 152, 162, may be locations within a vicinity of an event location 102. Event location 102 may be a location where an event may occur. In some examples, event location 102 may be a location where an event may be currently occurring. Examples of events which may occur at event location 102 include, but are not limited to, sports games, street protests, concerts, crimes, etc.

Device 140 may be configured to capture one or more images, or videos, and generate video data 146 based on the captured images and/or captured videos. Device 150 may be configured to capture one or more images, or videos, and generate video data 156 based on the captured images and/or captured videos. Device 160 may be configured to capture one or more images, or videos, and generate video data 166 based on the captured images and/or captured videos. Devices 140, 150, 160 may be configured to send video data 146, 156, 166 to the at least one relay server, respectively. The at least one relay server 130 may be configured to receive video data 146, 156, 166, and in response, may store video data 146, 156, 166 in a relay memory 132. Relay memory 132 may be configured to be in communication with the at least one relay server 130, and may be configured to store a relay instruction 134. Relay instruction 134 may include instructions that may be executed by relay server 130 to facilitate implementations of system 100.

The at least one communication server 120 may be configured to monitor the at least one relay server 130. In some examples, the at least one communication server 120 may determine a capacity of relay memory 132, and based on the capacity of relay memory 132, determine whether to assign relay server 130 to devices 140, 150, 160. In an example, the at least one communications server 120 may determine that a first capacity of a first relay memory, configured to be in communication with a first relay sever, is greater than a storage threshold. The at least one communication sever 120 may further determine that a second capacity of a second relay memory, configured to be in communication with a second relay server, is less than the storage threshold. In response to the first capacity being greater than the storage threshold, and the second capacity being less than the storage threshold, the at least one communication server 120 may assign one or more devices among devices 140, 150, 160 to the second relay server.

The at least one communication server 120 may be configured to be in communication with a communication memory 122, where communication memory 122 may be configured to store a communication instruction 124 and/or a database 126. The communication instruction 124 may include instructions effective to be executed by the at least one communication server 120 to facilitate implementation of system 100. Database 126 may include state data related to states of system 100, such as data effective to indicate assignments of relay servers to devices such as devices 140, 150, 160. In some examples, database 126 may include data effective to indicate one or more video data currently being processed, and/or one or more video data that were processed, by devices 140, 150, 160. In some examples, database 126 may include data effective to indicate communication links among the at least one relay server 130. The at least one communication server 120 may control, maintain, and/or modify data in database 126 in response to assigning the at least one relay server 130 to new devices, or in response to changes in assignments of relay server 130 to devices 140, 150, 160.

In an example, user 141 may be at a location 142, where location 142 may be within event location 102, or may be within a vicinity of event location 102. When user 141 is in location 142, user 141 may use device 140 to capture one or more images or videos to generate video data 146. Video data 146 may include images or videos corresponding to a perspective 144. The perspective 144 may relate to a position and/or angle in which user 141 views an event occurring at event location 102, through device 140, when user 141 is at location 142. In some examples, device 140 may generate location data 148, where location data 148 may be an indication of location 142. In some examples, device 140 may include a global positioning system (GPS) component that may be configured to generate location data 148. Device 140 may send video data 146 and location data to the at least one relay server 130. The at least one relay server 130 may receive video data 146 and location data 148. Device 140 may send video data 146 and location data 148 to the at least one relay server 130.

Similarly, user 151 may be at a location 152, where location 152 may be within event location 102, within a vicinity of location 142, and/or may be within a vicinity of event location 102. When user 151 is in location 152, user 151 may use device 150 to capture one or more images or videos to generate video data 156. Video data 156 may include images or videos corresponding to a perspective 154. The perspective 154 may relate to a position and/or angle in which user 151 views an event occurring at event location 102, through device 150, when user 151 is at location 152. In some examples, device 150 may generate location data 158, where location data 158 may be an indication of location 152. In some examples, device 150 may include a global positioning system (GPS) component that may be configured to generate location data 158. Device 150 may send video data 156 and location data 158 to the at least one relay server 130. The at least one relay server 130 may receive video data 156 and location data 158. Device 150 may send video data 156 and location data 158 to the at least one relay server 130.

Similarly, user 161 may be at a location 162, where location 162 may be within event location 102, within a vicinity of locations 142, 152, and/or may be within a vicinity of event location 102. When user 161 is in location 162, user 161 may use device 160 to capture one or more images or videos to generate video data 166. Video data 166 may include images or videos corresponding to a perspective 164. The perspective 164 may relate to a position and/or angle in which user 161 views an event occurring at event location 102, through device 160, when user 161 is at location 162. In some examples, device 160 may generate location data 168, where location data 168 may be an indication of location 162. In some examples, device 160 may include a global positioning system (GPS) component that may be configured to generate location data 168. Device 160 may send video data 166 and location data 168 to the one or more relay server 130. The one or more relay server 130 may receive video data 166 and location data 168. Device 160 may send video data 166 and location data 168 to relay server 130. In some examples, the one or more relay server 130 may request location data 148, 158, 168 from devices 140, 150, 160, periodically.

The one or more relay server 130 may receive video data 146, 156, 166 and/or location data 148, 158, 168. The one or more relay server 130 may store video data 146, 156, 166 and/or location data 148, 158, 168 in relay memory 132. In some examples, the one or more relay server 130 may send video data 146, 156, 166 and/or location data 148, 158, 168 to processor 110. The processor 110 may receive video data 146, 156, 166 and/or location data 148, 158, 168, and in response, may store video data 146, 156, 166 and/or location data 148, 158, 168 in central memory 112.

In an example, based on location data 148, processor 110 may determine that device 140 is located at location 142. In response to determining that device 140 is located at location 142, processor 110 may compare location data 148 with one or more pieces of stored location data 114 that may be stored in central memory. Stored location data 114 may correspond to respective locations that may include event locations (such as event location 102), or locations of other devices. Processor 110 may determine a distance between location 142 and each respective location that corresponds to stored location data 114 based on the comparison of location data 148 with stored location data 114. Processor 110 may compare the determined distances with a threshold 116 that may be stored in central memory 112.

In response to a determined distance being less than threshold 116, the processor 110 may determine that location 142 is located within a vicinity of an existing event. The processor 110 may associated video data 146 with the existing event, and with other video data that are associated with the existing event. The processor 110 may generate aggregated data 118 based on video data 146 and the other video data associated with the existing event, where aggregated data 118 may include one or more pieces of video data associated with the existing event.

In response to a determined distance being greater than threshold 116, the processor 110 may determine that location 142 is outside of a vicinity of an existing event, generate an indication of a new event, and may associate the new event with device 140. In an example, the processor 110 may receive location data 158 after receipt of location data 148. The processor 110 may compare location data 158 with stored location data 114 to determine a distance difference between location 152 and respective locations, including location 142, that corresponds to stored location data 114. If a distance difference between location data 158 and location data 148 is less than threshold 116, the processor 110 may determine that location 152 is within a vicinity of an event associated with device 140. In response to the determination that location data is within a vicinity of the event associated with device 140, the processor 110 may associate video data 156 with video data 146, and may generate aggregated data 118 based on video data 146 and video data 156.

In some examples, a first relay server of the at least one relay server 130 may send one or more pieces of video data to a second relay server of the at least one relay server 130 in order to relay video data from a first device to a second device. For example, device 140 may be configured to send video data 146 to a first relay server, and device 150 may be configured to send video data 156 to a second relay server. User 151 may use device 150 to request to view a video associated with video data 146, such as by sending a request signal to the second relay server. The second relay server, in response to receipt of the request signal, may request the first relay server for video data 146. The first relay server may send video data 146 to the second relay server such that the second relay server may send video data 146 to device 150. In some examples, the at least one relay server 130 may use a WEBRTC implementation based on MEETCHO's JANUS GATEWAY, or IONIC browser platform, etc., to communicate with various web browsers and/or mobile platforms that may be executed by devices 140, 150, 160. In some examples, the at least one relay server 130 may implement hypertext transfer protocol (HTTP) based media streaming communications protocol, such as HTTP live streaming (HLS), to communicate with various web browsers and/or mobile platforms that may be executed by devices 140, 150, 160. In some examples, the processor 110 may be a streaming engine configured to be in communication with the at least one relay server 130 and the at least one communication server 120, where the processor 110 may be configured to execute an application associated with system 100 on devices 140, 150, 160.

Among other benefits, a system in accordance with this disclosure may facilitate the streaming and viewing of multi-perspective live broadcasts, the grouping of streams into events, and the editing of archived streams into archived events. The system in accordance with this disclosure may server as a platform where users may initiate broadcasts, view live or archived video content, and search for events by applying various filters as described above and/or in FIGS. 1-10. The system may enable users to gain a broad understanding of events, such as by observing the events through the multiple perspectives of streamers attending or participating in events. Events and streams may be ordered based on user activity and popularity. The system may achieve the organization of streams into events by using location-based instructions to calculate an amount of streamers combined with space between streamers to determine a geographical size and location of an entire event. The system may further archive, such that users may view an entire event, including multiple perspectives of the event, after the event has already occurred.

Users may make information requests to communication servers, which can serve a list of events, streams and archived videos. The relay servers may process multimedia data across the platform, such as by saving and redistributing video and audio clips, originating from a broadcasting endpoint (e.g., a location of a user and/or user device) to other devices. One or more relay servers of the at least one relay server 130 may further accept and relay streams from other relay servers of the at least one relay server 130 such that through daisy chaining and broadcasting to endpoint time synchronization, a single broadcaster can reach any number of viewers. The at least one communication server 120 may mediate between user devices, such as devices 140, 150, 160, and the at least one relay server 130 by, for example, generating authentication tokens to initiate communication between the user devices, 140, 150, 160 and the at least one relay server 130. The at least one communication server 120 may further maintain an accurate system state, in an external data store, that describes the entire mapping between user devices 140, 150, 160, the at least one relay server 130, and streams. Optimization of the platform may be achieved by iteratively shifting streams between relay servers of the at least one relay server 130, consolidating or expanding streams across multiple relay servers of the at least one relay server 130, and moving endpoint connections around.

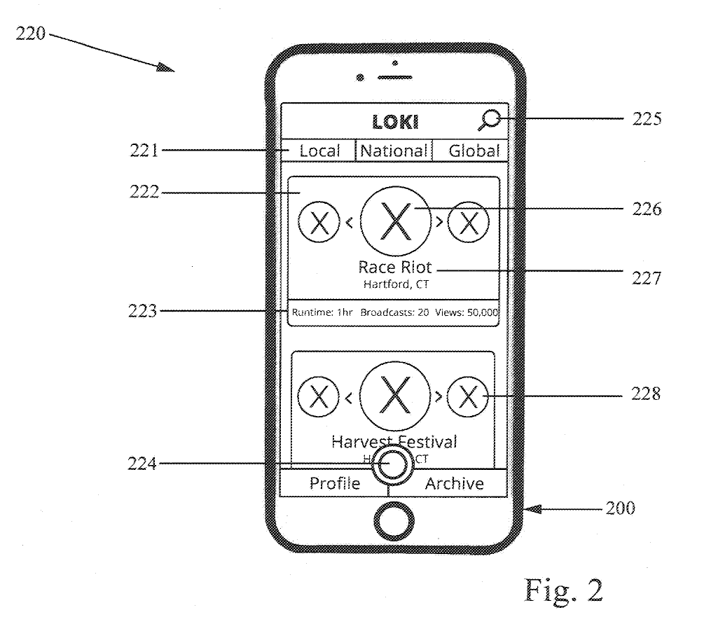

As shown in FIG. 2, devices 140, 150, 160 may each be configured to execute an exemplary interface 200, such as a graphical user interface (GUI), which may be operated using a touch-sensitive display, of a smartphone for example, a remote or other electronic control device, or any other suitable device for interacting with the interface 200. In general, in embodiments, the interface 200 enables a user to request video data from the at least one relay server 130, send video data to the at least one relay server 130, request that the processor 110 generate aggregated data 118, search for video data (such as video data 146, 156, 166) , capture video data 146, 156, 166, navigate among videos and/or events, etc.

The interface 200 may include an event page 220, which provides users with access to recorded and live events being streamed. The event page 220 may include a number of display features or “buttons” providing a user with information or allowing a user to interact with the interface 200. For example, the event page 220 may include a location filter 221 by which users can filter streamed events based on whether they want a focus on what is happening in their local towns, nationally significant events, and even global news. The event page 220 may include an event card 222, wherein each card represents a single event and within each event users are able to see the title of the event, where the event is occurring, specific data on the event, and all the different streams of the event. The event page 220 may include event data 223, shown as a portion of the event card 222, which shows data to users related to the entire event, for example, showing the total runtime of the event, the total number of people streaming the event, and the number of people viewing the entire event.

The event page 220 may include a record button 224 allowing users to begin streaming and, further, showing a thumbnail or title of the event within the button if a user is within the physical location of an already existing event. The event page 220 may include a search button 225 allowing users to conduct an advanced search, by which they can search by typing the name of an event, or by a specific category of interest. The event page 220 may include a current stream button 226, which may show the user the most popular stream being viewed out of the entire event, an image of the actual stream so that a viewer can understand the perspective of the respective stream. The current stream button may also allow a user to view the live feed by tapping on the display image (i.e., the current stream button 226).

The event page 220 may include an event title and location button 227 displaying the title and location of the event being streamed by multiple users, wherein the title may be generated by the user who starts streaming in an area where no other event is occurring. Alternatively, the title may be automatically generated by accessing the location of the devices that are streaming and determining an appropriate title. Additionally, a user may tap the location to bring up a map with pins of the exact location of the streamers of that event. The event page 220 may include a next stream button 228, which may show the user the next most popular stream. Users may tap either an arrow or a circular thumbnail to rotate the button to the center of the card. This operation may be performed on both the left side as well as the right side of the card. Continuing to tap one side may continue to rotate-in other streams of lower popularity, while continuing to tap the opposite side may continue to rotate-in other streams of higher popularity.

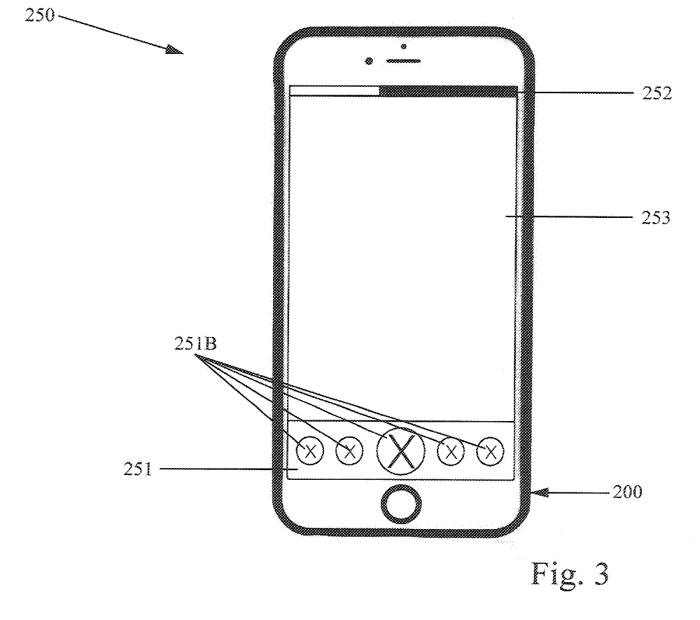

As shown in FIG. 3, devices 140, 150, 160 may each be further configured to execute interface 200 so as to include a viewer page 250 where users may, for example, select, watch and rate one or more videos. The viewer page 250 may, for example, include a stream nav bar 251. The stream nav bar 251 may contain one or more stream view buttons 251B. A button of the one or more stream view buttons 251B may be shown for each of the current live streams in the event. The stream nav buttons 251B may show images or their streams. To switch streams, users may either swipe to the left or right of a content section 253. Alternatively, users may navigate by swiping through the stream nav bar 251 to view all other possible streams within the event. The viewer page 250 may include emotions data 252 showing users the “like to dislike” ratio of the streams. For example, a light/bright color may represent likes, while a dark color may represent dislikes. The displayed “like to dislike” ratio of the emotions data 252 may fluctuate in real time. The content section 253 of the viewer page 250 may display to users the actual content of the stream they are viewing. Users may be able to swipe left or right on the content section 252 to switch to the next stream in the list of streams. Interface 200 may include an indicator in order to show a user a rating of a current video being shown. In some examples, the processor 110 may be configured to generate aggregated data 118 based on the ratings (for example, the “like to dislike” ratio or other suitable means for determining video quality from user feedback) of one or more videos that correspond to video data such as video data 146, 156, 166. In some examples, each piece of video data may include one or more portions, where each portion may correspond to a respective segment of a video associated with corresponding video data. The processor 110 may be configured to generate aggregated data 118 based on ratings of one or more segments of videos.

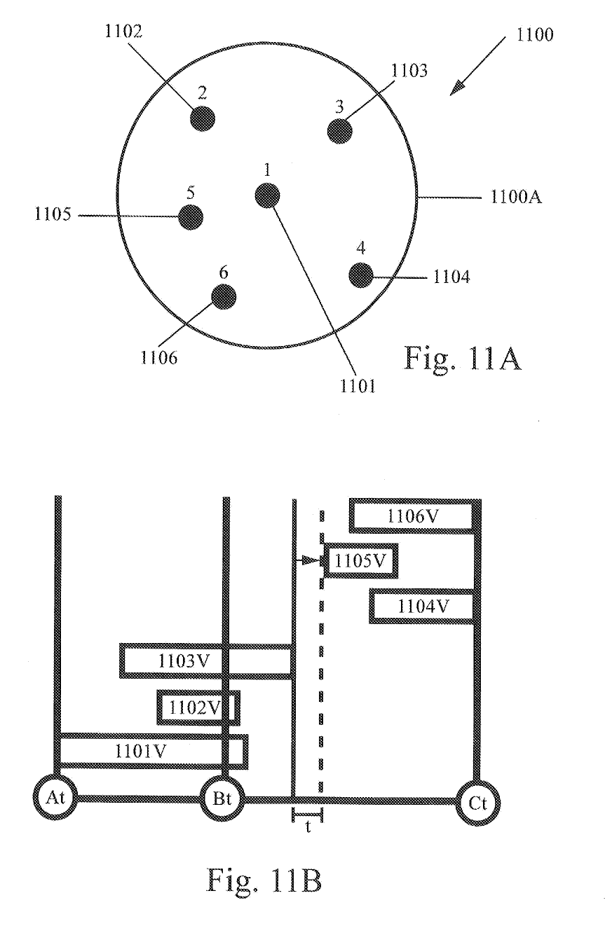

FIGS. 11A-B and 12A-C show an exemplary interface 200′. FIG. 11A shows a plurality of streamers 1101-1106, within an event area 1100A of an event 1100. As will be discussed in further detail, each of the video data 1101V-1106V, created by the respective streamers 1101-1106 within the event area 1100A have been determined, by the processor 110, to be associated (or “linked”) with one another based on their location within the event area 1100A of the event 1100. FIG. 11B shows the generation of aggregated data 118, by the processor 110, along an event timeline, wherein the video data 1101V-1106V streamed by each streamer 1101-1106 is represented by a bar at the times, during the event 1100, that the streamer 1101-1106 was streaming. In the event timeline of FIG. 11B, the vertical line marking time Aₜ represents the beginning of the event 1100 (i.e., the time at which the first streamer, for example streamer 1101, of an event 1100 began streaming). The vertical line marking time Bₜ represents a point in the event timeline selected by a user for viewing. The vertical line marking time Cₜ represents the end of the event timeline or, alternatively, the current time (i.e., live stream) in an ongoing event.

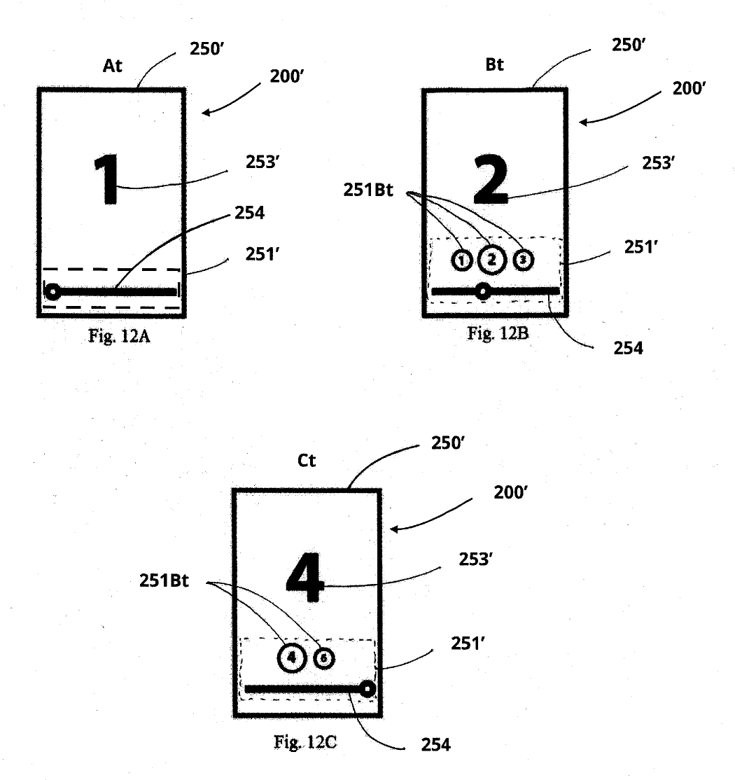

FIGS. 12A-12C show an exemplary page of interface 200′, which may be the viewer page 250′, at times Aₜ, Bₜ, Cₜ as shown in FIG. 11B. For example, in FIG. 12A, corresponding to the time of vertical line A, only video data from a streamer 1101 is available and the video data from the streamer 1101 is displayed in the content section 253′ of the viewer page 250′. An adjustable sliding bar 254, along the bottom of the viewer page 250′, shows the time of the video stream with respect to the event timeline. FIG. 12B, corresponding to the time of vertical line B, shows that video data from streamers 1101, 1102, 1103 is available. The video streams available to be viewed is illustrated by the circled numbers corresponding to the streaming user numbers in, for example, the stream nav bar 251′ of the viewer page 250′. The circled numbers may be, for example, the one or more stream nav buttons 251B′ of the stream nav bar 251′. The larger of the circled numbers (i.e., circled number 2) represents that a viewing user has selected the video data 1102V from streamer 1102 to be displayed in the content section 253′ of the viewer page 250′. A viewing user may select video data 1101V, 1103V from the other available streaming users (i.e., streamers 1101, 1103) by tapping on the associated circled numbers. FIG. 12C, corresponding to the time of vertical line C, shows that video data from streaming users 4, 6 is available. Because vertical line C represents the end of the event timeline, the video data of streamers 1104, 1106 at vertical line C may represent live video streams.

FIG. 11B further illustrates a gap time period t wherein no streamers are streaming, and therefore, no video streams of the event 1100 are available. For example, a user following the event 1100 during time period t would not be able to view any video streams of the event recorded during time period t. In this case, the interface 200′ may automatically change the selected time in the event timeline to the time corresponding to the next available video stream. For example, where a user is viewing event 1100, upon reaching time period t, the interface 200′ may automatically change the selected time of the event timeline to a time corresponding with the beginning of the video stream corresponding to streamer 1105, and additionally, may automatically select the video stream corresponding to streamer 1105 to be displayed in the content section 253′ of the viewer page 250′.

As shown in FIG. 4A, a “streamer” or first user (such as user 141, for example, who is witnessing or participating in an event, and begins streaming) of a first device (such as device 140) may begin streaming a first video (such as by sending video data 146 to the at least one relay server 130). The processor 110 may determine an event area (such as event area 140A), for example, when the user begins his or her stream, a circular area (as shown in FIG. 4A), for example, is generated around the user 141 based on a set predetermined radius and which may be the assumed location of an occurring event. The event area 140A may based on a predetermined radius from the user 141, 50 meters for example, or any other event area shape/size, based on location data 148 associated with video data 146.

As shown in FIG. 4B, when a “streamer” or second user (such as user 151) of a second device (such as device 150) begins streaming a second video (such as by sending video data 156 to the at least one relay server 130), within the event area 140A of the first user 141, the processor 110 may determine whether device 150 associated with user 151 is located within event area 140A. If the processor 110 determines that device 150 is within event area 140A, the processor 110 may automatically link video data 156 with video data 146. Thus, the second user's 151 stream may automatically be considered a part of the first user's 141 event. The linking of video data 156 with video data 146 may be an indication that videos corresponding to video data 146, 156 may be of a same event.

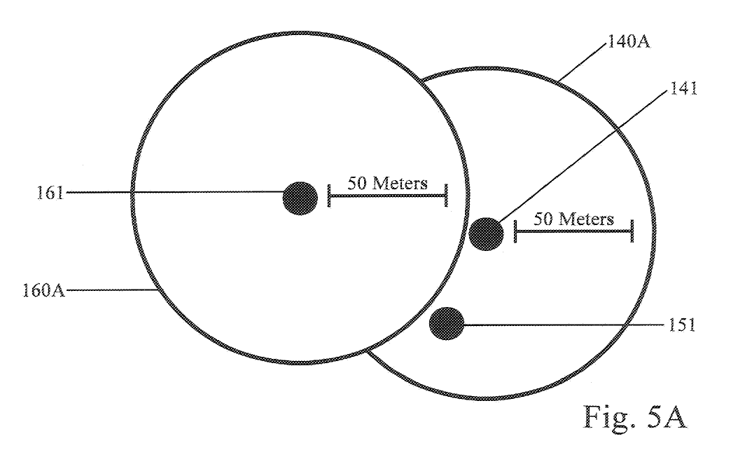

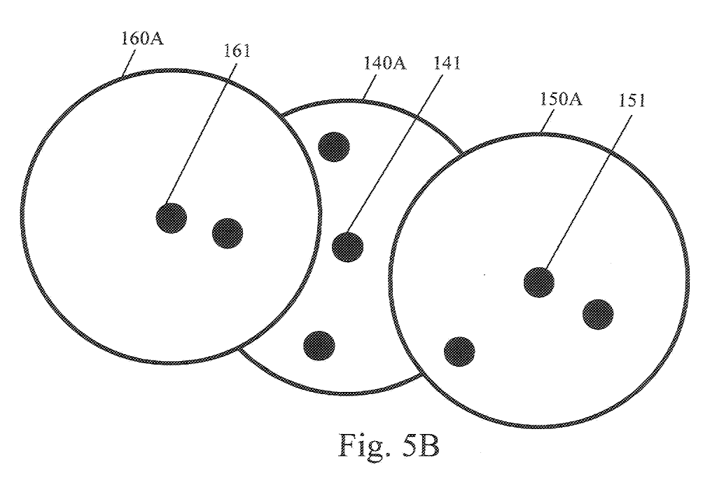

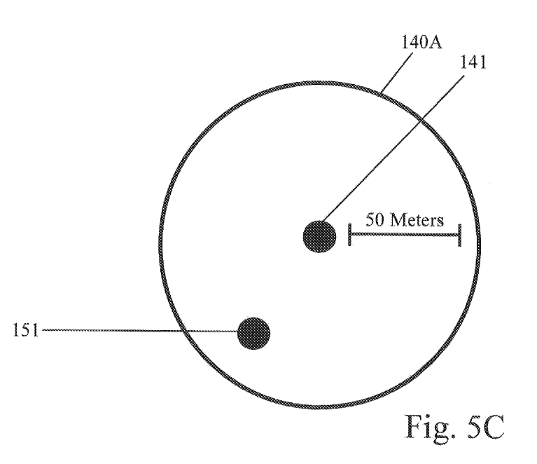

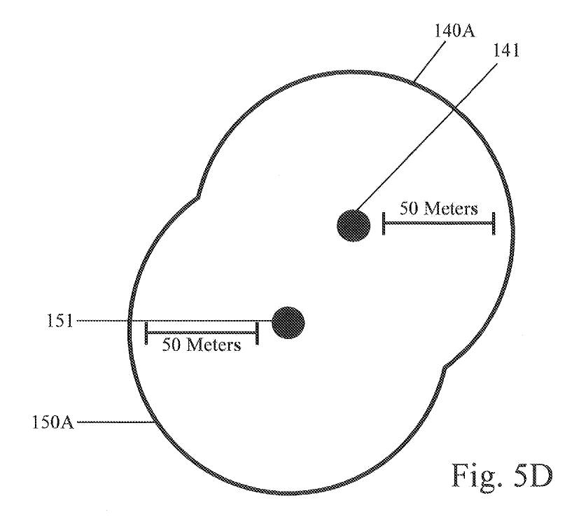

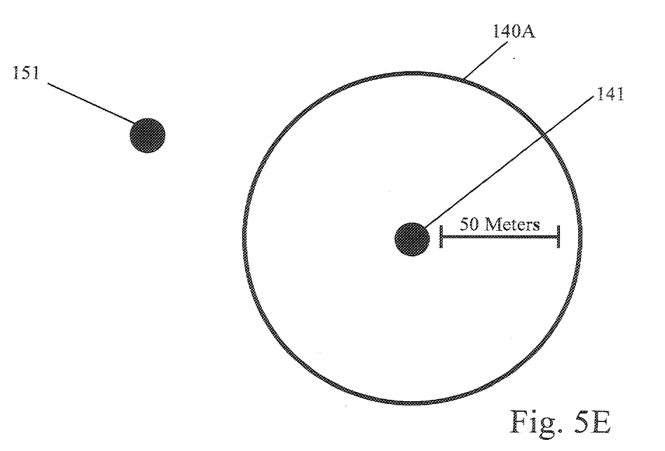

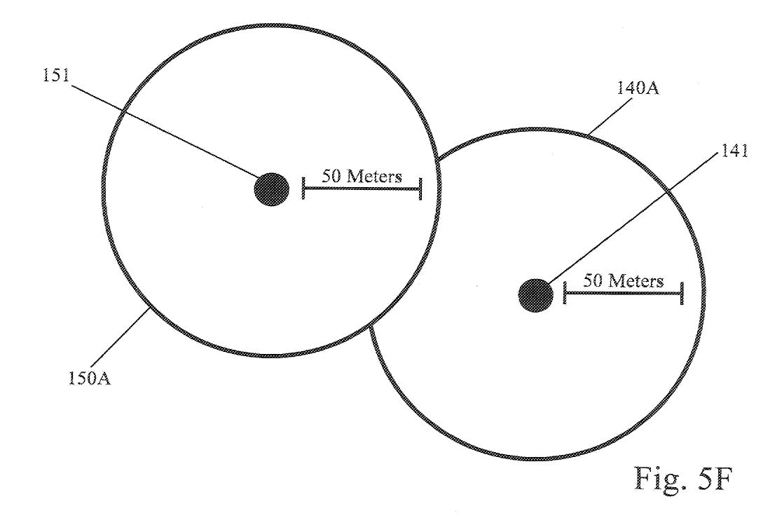

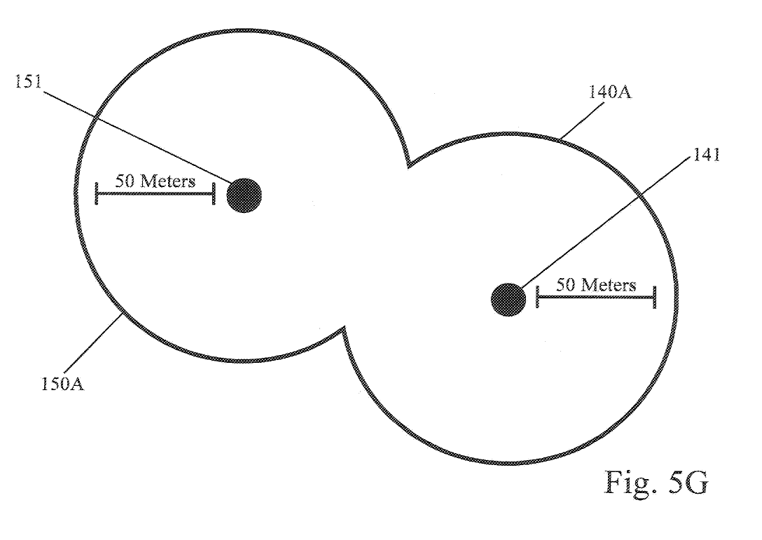

Referring to FIGS. 5A-5H, one or more of a number of alternative methods may be used by the processor 110 to determine whether the video data 146, 156, 166 of devices 140, 150, 160 associated with users 141, 151, 161, respectively, should be linked. For example, as shown in FIG. 5C, when a user 151 of device 150 begins streaming a video (such as by sending video data 156 to the at least one relay server 130), the processor 110 may determine whether device 150 (user 151) is located within event area (140A). As shown in FIG. 5D, the processor 110 may determine an event area (such as event area 150A) surrounding user 151, based on location 152 of device 150 and may further merge event area 140A and event area 150A into a combined event area.

Alternatively, if the processor 110 determines that device 150 (user 151) is outside of event area 140A (as shown in FIG. 5E), but an event area 150A surrounding user 151, based on location 152 of device 150, overlaps with event area 140A (as shown in FIG. 5F), then the processor 110 may merge event area 140A and event area 150A into a combined event area (as shown in FIG. 5G). By determining locations of devices and identifying overlapping areas surrounding devices, the processor 110 may expand the combined event area and may determine size, shape and/or boundaries of an event such as shown in FIG. 5B. If the processor 110 determines that device 140 and device 150 are within a combined event area (such as the combined event area formed by merging event area 140A and event area 150A), as in FIG. 5E, the processor 110 may link video data 156 of device 150 with video data 146 of device 140. The linking of video data 156 with video data 146 may be an indication that videos corresponding to video data 146, 156 may be of a same event.

In another example, as shown in FIG. 5A, if the processor 110 determines that a user (such as user 161) of a device (such as device 160) begins streaming a video (such as by sending video data 166 to the at least one relay server 130), the processor 110 may determine whether device 160 (user 161) is located outside event area 140A. Where device 160 is located outside of event area 140A, but an event area 160A surrounding user 161, based on location 162 of device 160, overlaps with event area 140A (wherein the video data 146, 156 of devices 140, 150 are linked as illustrated in FIG. 4B), then the processor 110 may merge event area 140A and event area 160A into a combined event area. By determining locations of devices and identifying overlapping areas surrounding devices, the processor 110 may expand the combined event area and may determine size, shape and/or boundaries of an event. If the processor 110 determines that devices 140, 150, 160 are within the combined event area (such as a combined event area formed by merging event area 140A and event area 160A), the processor 110 may also link video data 166 with video data 146, 156. The linking of video data 166 with video data 146, 156 may be an indication that videos corresponding to video data 146, 156, 166 may be of a same event.

As shown in FIGS. 5B and 5H, the processor 110 may continue to merge event areas and/or link video data 146, 156, 166 of devices 140, 150, 160 based on locations 142, 152, 162 of devices 140, 150, 160 using, for example, one or more of the methods previously discussed with respect to FIGS. 4B, 5A and 5C-5G. In one example, FIG. 5B shows three event areas 140A, 150A, 160A that have merged to become a combined event area. In another example, FIG. 5H shows the combined event area of FIG. 5D further merging with the event areas 170A, 180A of users 171, 181, respectively, to become one combined event area.

An example is shown in FIG. 6A, wherein event areas associated with users located within a stadium, may form a combined event area 600 in the shape of stadium seating. As mentioned above, by determining locations of devices and identifying overlapping areas surrounding devices, the processor 110 may expand the event area and may determine size, shape and/or boundaries of an event.

As shown in FIG. 6B, the system 100 may be further implemented to cluster the geo-location of devices in order to generate event areas on a map of the earth. For example, using the location filter 221 of event page 220 (see FIG. 3), a user may view only events located within geographic boundaries, such as, global, national, state, city or local geographic boundaries, or any other appropriate geographic boundaries. A grid superimposed over a region 610 (e.g., the State of Connecticut) illustrates an exemplary implementation of the processor 110 to determine at least one local area 620, represented by squares of the grid. While Connecticut is depicted as the region 610, larger or smaller geographical areas could be used. Depending on the number of events 630 occurring in the region 610, the geographic size of the at least one local area may be larger or smaller. For example, a region 610 having a large number of events 630 may cause the processor to determine a smaller geographic size of the at least one local area 620 within the region 620, compared to another region having fewer events 630. While depicted as squares, the at least one local area 620 may have any appropriate shape (e.g., circles) or may be a predetermined shape based on the boundary of, for example, a city.

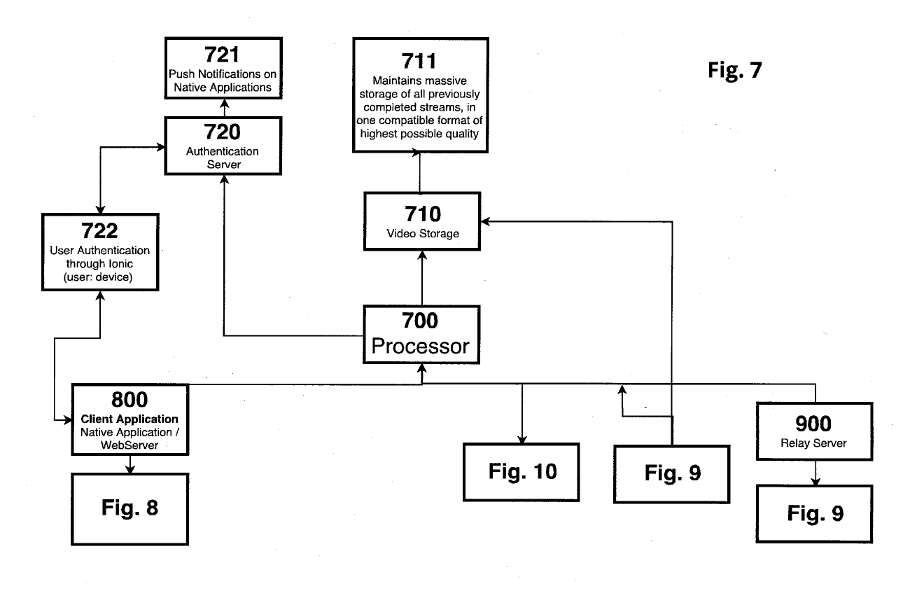

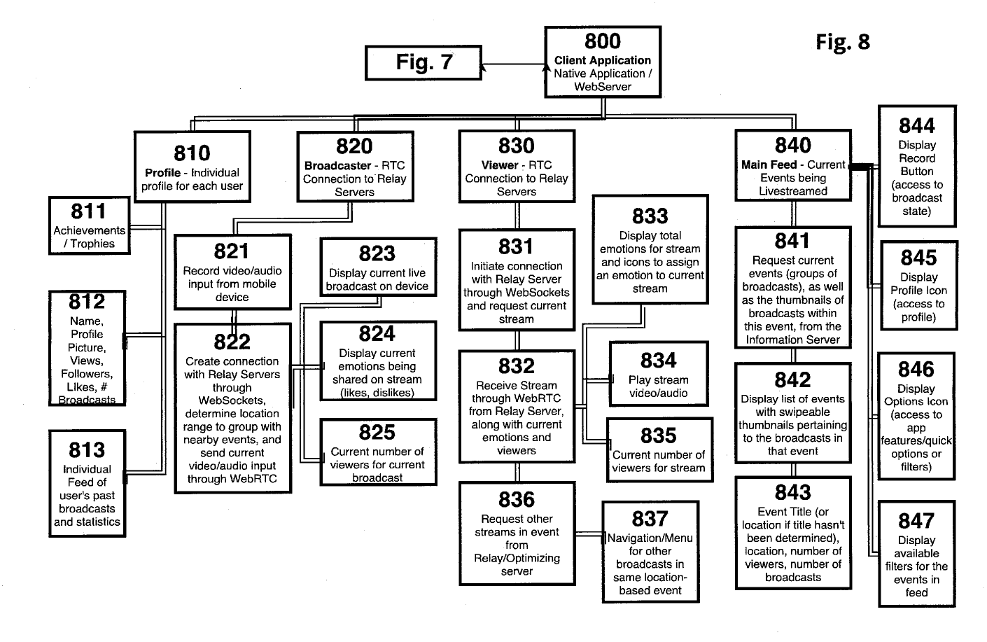

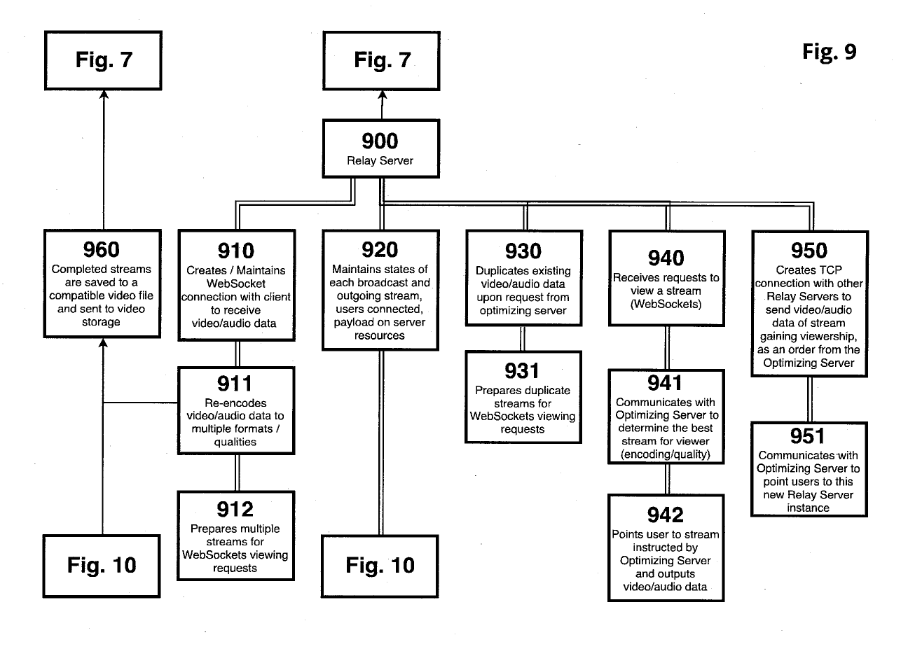

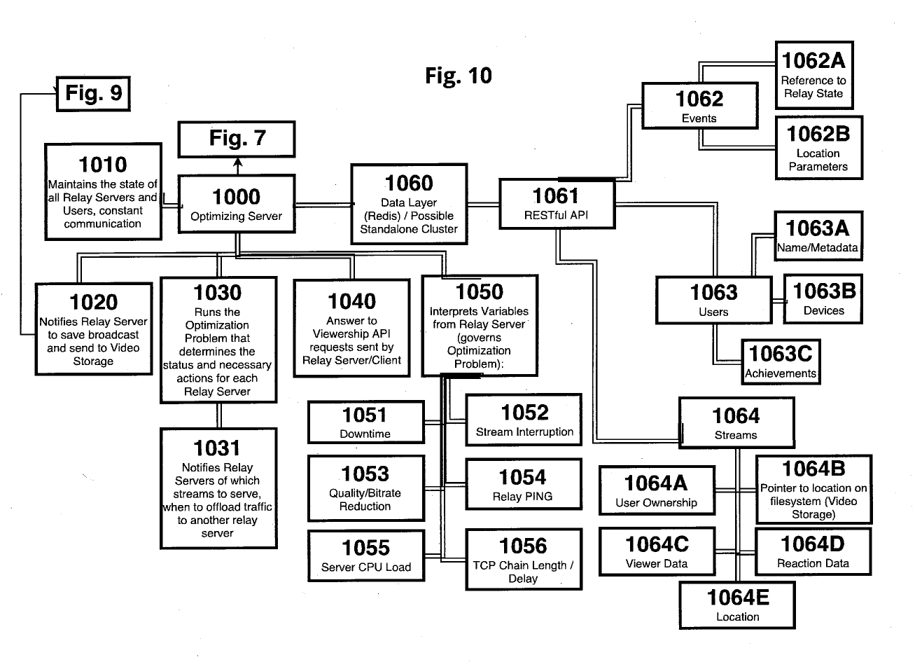

FIGS. 7-10 show a flowchart related to an exemplary implementation of system 100. A first portion of the example flowchart is shown in FIG. 7, where the first portion relates to the processor 110, devices 140, 150, 160, etc.

FIG. 7 shows the interaction of various components of a second embodiment described herein. The system includes a processor 700, in communication with video storage 710, an authentication server 720, a client application 800, at least one relay server 900 and an optimizing server 1000 (see FIG. 10). In some examples, processor 700 may be a processing unit of at least one communication server (not shown in FIG. 7) and/or the at least one relay server 900. The at least one relay server 900 may receive video data, such as video data 146, 156, 166, and/or location data, such as location data 148, 158, 168 in relay memory, such as relay memory 132. In some examples, the at least one relay server 900 may send video data 146, 156, 166 and/or location data 148, 158, 168 to processor 700. The processor 700 may receive video data 146, 156, 166 and/or location data 148, 158, 168, and in response, may store video data 146, 156, 166 and/or location data 148, 158, 168 in video storage 710. The video storage 710 may maintain storage of all previously completed streams in one compatible format. The processor 700 may direct the authentication server 720 to mediate between user devices, such as devices 140, 150, 160, and the at least one relay servers 900, such as by using mobile app software, for example Ionic, to authenticate users 722 in order to initiate communication between the user devices and at least one relay server 900. The authentication server 720 may also push notifications on native applications 721.

FIG. 8 illustrates a second portion of the flowchart relating to an exemplary implementation of system 100. The flowchart of FIG. 8 describes the features of a collaborative media distributor from the perspective of a client application 800 on an end-user's device 140, 150, 160. When the client application is downloaded, the user sets up a profile 810. The profile 810, which may be an individual profile for each user, may be automatically updated with achievements/trophies 811, user information, such as name, profile picture, views, followers, likes, and number of broadcasts 812, and an individual feed of the user's past broadcast and statistics 813.

A broadcaster 820 feature of the client application 800 may allow the client application 800 to connect, by an RTC connection for example, to the at least one relay server 900. The broadcasting user may, using the client application 800 record video/audio input from the mobile device 821, via the connection with the at least one relay server 900 through, WebSockets for example, determine a location range to group with nearby events, and send current video/audio input through WebRTC 822. The broadcaster 820 feature of the client application 800 may also allow the client application, via the connection with the at least one relay server 900, to display current live broadcasts 823, display current emotions being shared on a video stream 824, and display a current number of viewers for a current broadcast 825 on device 140, 150, 160.

The viewer 830 feature of the client application 800 provides a real-time connection to the relay servers allowing the user to watch video generated by broadcasting users. For example, the client application 800 may initiate a connection with the at least one relay server 900 through Websockets, for example, and request a current stream 831. The client application 800 may then receive the requested stream through WebRTC from the at least one relay server 900 at 832, along with current emotions and a number of viewers, and display the total emotions for the video stream and icons assigning an emotion to the video stream 833, play the video stream, or audio from the video stream 834, and display the current number of viewers for the video stream 835. The client application 800 may also request other linked video streams in the event from the at least one relay server 900 or an optimizing server 1000 at 836, and display the other linked video streams in a navigation menu for other broadcasts in the same location-based event 837.

The main feed 840 feature of the client application 800 provides the user with information about live and existing broadcast feeds and permits the user to select feeds for viewing. For example, the client application 800 may request current events (for example, groups of linked broadcasts), as well as the thumbnails of broadcasts within the respective current event, from the information server 841, display a list of current events with swipeable thumbnails pertaining to the broadcasts in that event 842 with an event title (or location if a title has not been determined) location, number of viewers, or a number of broadcasts) 843. The client application 800 may further display a record button providing a user with access to a broadcast state 844, display a profile icon providing a user with access to the user's profile 845, display an options icon providing a user with access to client application 800 features, options or filters 846, and display available filters for the events in the feed 847.

FIG. 9 illustrates a third portion of the flowchart relating to an exemplary implementation of the system 100 further describing the operation of the at least one relay server 900. The at least one relay server 900 may create and/or maintain, for example, a WebSocket connection with the client application 800 to receive video and audio data 910, re-encode the video data to multiple formats or qualities 911 and prepare multiple video streams for user viewing requests 912 and/or save the completed streams to a compatible video file in video storage 710 at 960. The at least one relay server 900 may maintain states of each broadcast and outgoing stream, user connections, and payloads on server resources 920 through coordination with the optimizing server 1000 (see FIG. 10). The at least one relay server 900 may duplicate existing video and audio data upon a request from the optimizing server 1000 at 930, and prepare the duplicate streams for WebSockets viewing requests 931. The at least one relay server 900 may receive requests to view a stream (via, for example, WebSockets) 940, communicate with the optimizing server 1000 to determine the best stream for the requesting viewer (e.g., encoding or video/audio quality) 941, and output video/audio data, associated with a stream determined by the optimizing server 100, to a user 942. The at least one relay server 900 may also create a TCP connection with other relay servers to send video/audio data of a stream gaining viewership, based on instructions from the optimizing server 950, and communicate with the optimizing server 1000 to point users to this new relay server instance 951.

FIG. 10 illustrates a fourth portion of the flowchart relating to an exemplary implementation the system 100 further describing the operation of the optimizing server 1000. The optimizing server 1000 may maintain the state of the at least one relay server 900 (see FIG. 9) and communication with users 1010. The optimizing server 1000 may notify the at least one relay server 900 (see FIG. 9) to save a broadcast and send the broadcast to video storage 710 at 1020. The optimizing server 1000 may run an optimization problem to determine the status and necessary actions for each of the at least one relay server 900 at 1030 and notify the respective relay servers of the at least one relay server 900 of which streams to serve and when to offload traffic to another of the at least one relay server 900 at 1031. The optimizing server 1000 may answer viewership application program interface (API) requests sent by the at least one relay server 900 or the client application 800 at 1040. The optimizing server 1000 may interpret variables, which may be used in the optimization problem, from the at least one relay server 900 at 1050, such as downtime 1051, stream interruption 1052, quality/bitrate reduction 1053, relay PING 1054, server CPU load 1055, and TCP chain length/delay 1056. The data layer 1060 acts as an interface between persistent data (stored in relational databases) and the client application 800 or other proprietary application code. The RESTful API 1061 is a form of proprietary application code which uses the data layer 1060 and provides a way for client applications to read and write data to persistent data storage, for example, through HTTP.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for generating aggregated data associated with an event, the system comprising:
at least one relay server;
at least one communications server; and
a processor in communication with at least one of the at least one relay server and the at least one communication server via a network, the processor configured to
receive first video data and first location data associated with a first device from the one or more relay server;
determine a first location of the first device based on the first location data;
generate a first event area associated with the first device based on at least one of the first location and a predetermined event location;
receive second video data and second location data associated with a second device from the one or more relay server;
determine a second location of the second device based on the second location data;
generate a second event area associated with the second device based on the second location;
determine the first event area and second event area overlap, merge the first event area and the second event area into a combined event area and link the second video data with the first video data; and
generate the aggregated data, in response to the linking of the first video data and the second video data, wherein the aggregated data includes the first video data and the second video data.

2. The system of claim 1, wherein the at least one communication server is in communication with one or more of the at least one relay server and at least one device.

3. The system of claim 1, wherein the processor is configured to control operation of at least one of the at least one relay server and the at least one communication server.

4. The system of claim 1, wherein the processor is a processing unit of at least one of the at least one relay server and the at least one communication server.

5. The system of claim 1, wherein a first relay server of the at least one relay server is configured to send video data to a second relay server of the at least one relay server.

6. The system of claim 1, wherein the processor is further configured to generate aggregated data based on ratings of one or more videos corresponding to video data.

7. The system of claim 1, wherein the video data may include one or more portions, and wherein each portion may correspond to a respective segment of a video associated with the corresponding video data.

8. The system of claim 1, wherein the processor is further configured to generate aggregated data based on ratings of one or more video segments.

9. The system of claim 1, wherein the at least one relay server is configured to be in communication with at least one device.

10. The system of claim 9, further comprising a relay memory in communication with the at least one relay server, wherein the at least one relay server is configured to receive video data, and in response, store video data in the relay memory.

11. The system of claim 10, wherein the at least one communication server is configured to monitor the at least one relay server.

12. The system of claim 11, wherein the at least one communication server determines a capacity of relay memory, and based on the capacity of relay memory, determines whether to assign the at least one relay server to the at least one device.

13. A method for generating aggregated data associated with an event, the method comprising:
receiving first video data and first location data from a first device;
determining a first location of the first device based on the first location data;
generating a first event area associated with the first device based on at least one of the first location and a predetermined event location;
receiving second video data and second location data from a second device;
determining a second location of the second device based on the second location data;
generating a second event area associated with the second device based on the second location;
determining the first event area and second event area overlap, merging the first event area and the second event area into a combined event area and linking the second video data with the first video data; and
generating the aggregated data, in response to the linking of the first video data and the second video data, wherein the aggregated data includes the first video data and the second video data.

14. A non-transitory computer-readable medium having stored thereon sequences of instructions which, when executed by a processor, cause the processor to:
receive first video data and first location data from a first device;
determine a first location of the first device based on the first location data;
generate a first event area associated with the first device based on at least one of the first location and a predetermined event location;
receive second video data and second location data from a second device;
determine a second location of the second device based on the second location data;
generate a second event area associated with the second device based on the second location;
determine the first event area and second event area overlap, merge the first event area and the second event area into a combined event area and link the second video data with the first video data; and
generate the aggregated data, in response to the linking of the first video data and the second video data, wherein the aggregated data includes the first video data and the second video data.
